(19) United States
(12) Patent Application Publication
(10) Pub. No.: US 2012/0167222 A1
(43) Pub. Date: Jun. 28, 2012

(54) METHOD AND APPARATUS FOR DIAGNOSING MALICOUS FILE, AND METHOD AND APPARATUS FOR MONITORING MALICOUS FILE

(75) Inventors: Ik Kyun KIM, Daejeon (KR); Yang-Seo CHOI, Daejeon (KR); Byoung-Koo KIM, Daejeon (KR); Seung Yong YOON, Daejeon (KR); Youngjun HEO, Daejeon (KR); Dae Won KIM, Daejeon (KR); Il AHN CHEONG, Daejeon (KR); Jintae OH, Daejeon (KR); Jong Soo JANG, Daejeon (KR)

(73) Assignee: Electronics and Telecommunications Research Institute, Daejeon (KR)

(21) Appl. No.: 13/335,811

(22) Filed: Dec. 22, 2011

(30) Foreign Application Priority Data
Dec. 23, 2010 (KR) 10-2010-0133929

(51) Int. Cl. G06F 21/00

(52) U.S. Cl. 726/24

(57) ABSTRACT

An apparatus for diagnosing malicious files includes a information transferring unit configured to receive information regarding a malicious file distributed in a management network and an execution file generated by assembling packets collected from the management network; an anti-virus engine configured to determine whether or not the execution file is malicious to generate information regarding a new malicious file; and a management unit configured to transfer the information regarding the malicious file and the information regarding the new malicious file to a terminal device on the management network through the information transferring unit.

### CROSS-REFERENCE TO RELATED APPLICATION(S)

The present invention claims priority of Korean Patent Application No. 10-2010-0133929, filed on Dec. 23, 2010, which is incorporated herein by reference.

### FIELD OF THE INVENTION

The present invention relates to diagnosing and monitoring a malicious file, and more particularly, to a malicious file diagnosis method and apparatus for managing malicious files in a network on a cloud computing basis, and a malicious file monitoring method and apparatus for monitoring transfer and distribution of malicious files in a network.

### BACKGROUND OF THE INVENTION

A general countermeasure to a malicious file such as a computer virus, a Trojan horse, or the like is utilizing an anti-virus engine in a terminal device. In general, anti-virus products, which are installed and periodically updated in a personal computer (PC) or a mobile terminal, compares patterns of files introduced from various input/output (I/O) devices by using a signature (detection pattern), to thus determine whether or not the files are malicious.

However, if a new signature cannot be accurately distributed or updated timely to a terminal device, when the user terminal is infected, the technique of utilizing such an anti-virus engine cannot detect the infection and properly cope with it. At present, since a signature differs from each product, and a signature sharing system is not made, the technique is dependent on the capabilities of some particular products. In addition, although it is determined that a malicious code has been introduced to the terminal device, it is not possible to track the infection path, and additional information for a follow-up measure (e.g., a malicious code distributor IP) is not being shared.

Besides, another conventional countermeasure is a virus-wall, which is a kind of network-based anti-virus engines.

However, in such a virus-wall, since a calculation load for signature (pattern) matching is too large to block malicious files on the network, it is not generalized for the reason of performance, and the virus-wall follows the same problem of the anti-virus engine. In addition, due to gradual enhancement of network performance, it is anticipated that the virus-wall will have a difficult to exhibit an effect in a network in the future.

### SUMMARY OF THE INVENTION

In view of the above, the present invention provides a malicious file diagnosis method and apparatus for managing malicious files in a network-on a cloud computing basis, and a malicious file monitoring method and apparatus for monitoring transfer and distribution of malicious files in a network for use in the malicious file diagnosis method and apparatus.

In accordance with a first aspect of the present invention, there is provided an apparatus for diagnosing malicious files, the apparatus including:

a information transferring unit configured to receive information regarding a malicious file distributed in a management network and an execution file generated by assembling packets collected from the management network;

an anti-virus engine configured to determine whether or not the execution file is malicious to generate information regarding a new malicious file; and

a management unit configured to transfer the information regarding the malicious file and the information regarding the new malicious file to a terminal device on the management network through the information transferring unit.

In accordance with a second aspect of the present invention, there is provided a method for diagnosing malicious files, the method comprising:

receiving information regarding a malicious file distributed in a management network and an execution file generated by assembling packets collected from the management network;

determining whether or not the execution file is malicious by using an anti-virus engine;

generating information regarding a new malicious file based on the determination result; and

transferring the information regarding the malicious file and the information regarding the new malicious file to a terminal device on the management network.

In accordance with a third aspect of the present invention, there is provided an apparatus for monitoring malicious files, the apparatus including:

a packet collection unit configured to collect packets from a network when the packets are recognized as candidate packets of execution files;

an information transferring unit configured to assemble the collected candidate packets to generate an execution file;

an index storage unit configured to store an index of malicious files;

a comparison unit configured to compare an index of the execution file with the indices of the malicious files stored in the index storage unit to determine whether or not the execution file is a malicious file based on the comparison result;

a malicious file analyzing unit configured to determine whether or not the execution file, which has not been determined by the comparison unit, is a malicious file; and

an information transferring unit configured to transfer the determination result for the execution files obtained by the comparison unit and the malicious file analyzing unit to the network so that the result is used to diagnose the malicious files.

In accordance with a fourth aspect of the present invention, there is provided a method for monitoring malicious files, the method including:

collecting packets from a network when the packets are recognized as candidate packets of execution files;

assembling the candidate packets to generate an execution file;

extracting an index including a hash value from the execution file;

comparing the index of the execution file with the indices of malicious files to determine whether or not the execution file is a malicious file; and

transferring a determination result to the network so that the determination result is used to diagnose or remove malicious files.

### BRIEF DESCRIPTION OF THE DRAWINGS

The above and other objects and features of the present invention will become apparent from the following description of embodiments, given in conjunction with the accompanying drawings, in which:

FIG. 1 shows the configuration of a cloud computing-based network system employing a malicious file diagnosis apparatus and a malicious file monitoring apparatus in accordance with an embodiment of the present invention;

FIG. 2 illustrates various types of information being exchanged for diagnosing and monitoring malicious files in the cloud computing-based network system in accordance with the embodiment of the present invention;

FIG. 3 illustrates a detailed block diagram of the monitoring apparatus shown in FIG. 1;

FIG. 4 shows a flowchart for explaining a process of testing an execution file in the monitoring apparatus shown in FIG. 1;

FIG. 5 presents a detailed block diagram of the diagnosis apparatus shown in FIG. 1; and

FIG. 6 depicts a detailed block diagram of malicious file removing agents shown in FIG. 1.

### DETAILED DESCRIPTION OF THE EMBODIMENTS

Hereinafter, examples of the present invention will be described in detail with reference to the accompanying drawings.

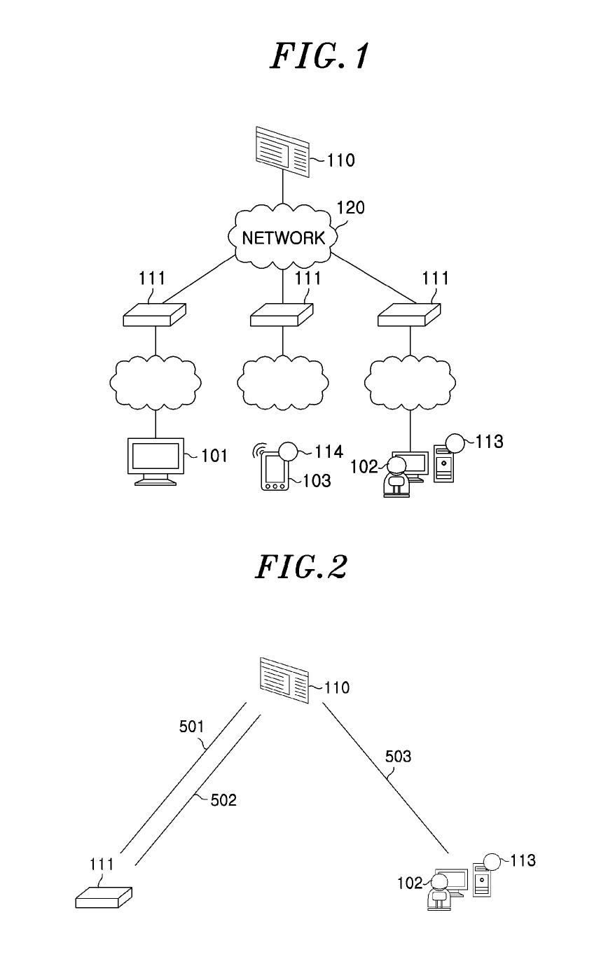

FIG. 1 shows the configuration of a cloud computing-based network system employing a malicious file diagnosis apparatus and a malicious file monitoring apparatus in accordance with an embodiment of the present invention.

The network system shown in FIG. 1 includes a malicious file diagnosis apparatus 110, a malicious file monitoring apparatus 111, malicious file removing agents 113 and 114. The malicious file removing agents 113 and 114 are installed in a personal computer (PC) 102 and a mobile terminal 103 such as a personal data assistant (PDA) and a cellular phone. Reference numeral 101 represents a web server in which a malicious file removing agent may be installed.

First, a distribution path of malicious codes on a network 120, e.g., Internet, will be described as follow.

In most cases, when the terminals 102 and 103 attempt normal accessing the web server 101, a malicious file or code is downloaded and installed in the terminal devices without their knowledge or shared via a communication scheme such as peer-to-peer (P2P). In this case, there may be a large deviation in countermeasure result in detection of the malicious file depending on a current state and detection performance of an anti-virus product installed in the terminals. Therefore, the detection of a malicious file has only depended on the anti-virus product.

The monitoring apparatus 111 is positioned at a bottleneck of an enterprise network or a subscriber network to monitor packets being distributed in the network 120, collects a series of packets related to execution files, and assembles the same. The monitoring apparatus 111 determines whether an assembled execution file is a known malicious execution file or a known normal file by indexing hash value and file length of the execution file through database searching. When there is no information about the execution file indexing in the searched database, the monitoring apparatus 111 determines whether the execution file is an unknown malicious file through its own malicious file analyzing technique. The monitoring apparatus 111 may categorizes the execution file collected from the network 120 into one of a known malicious file, a known normal file, an unknown malicious file, and an unknown normal file. In case of a known malicious file, the monitoring apparatus 111 transmits information such as IP, port, time information, file index, etc. regarding a distribution route to the diagnosis apparatus 110. In case of an unknown malicious file or an unknown normal file, the monitoring apparatus 111 transmits an actually assembled file, along with the foregoing information, to the diagnosis apparatus 110. When the information regarding a known malicious file is received from the monitoring apparatus 111, the diagnosis apparatus 110 immediately transfers the information to the malicious file removing agents 113 and 114 installed in the terminal, for example, the terminal 102 or 103 having the destination IP of the malicious file so that the terminal can recognize and remove the malicious file.

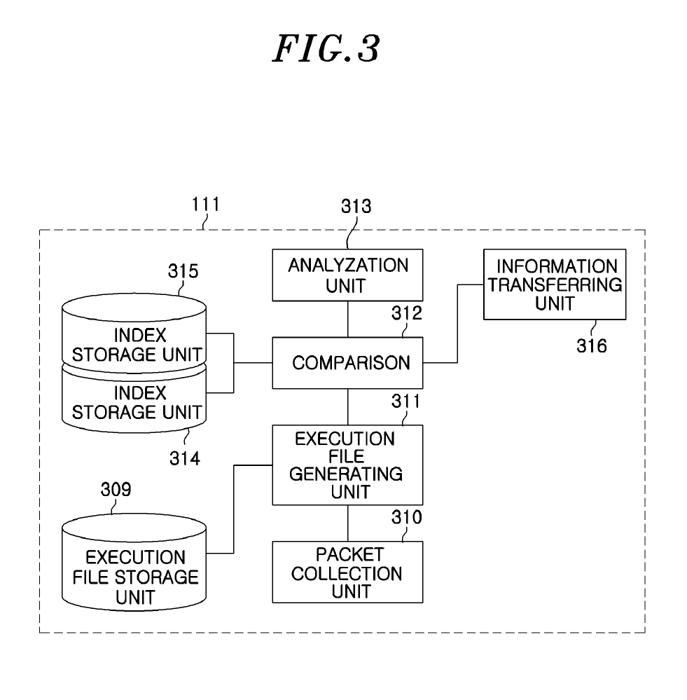

FIG. 2 illustrates types of information being exchanged between the diagnosis apparatus 110, the monitoring apparatus 111, and the malicious file removing agent 113 in the cloud computing-based network system.

Information 502 transferred from the diagnosis apparatus 110 to the monitoring apparatus 111 is information regarding a malicious file and a normal file that are already known through various routes. The information 502 includes <FILE INDEX, MALICIOUS FILE NAME> for the known malicious file and normal file, and is used as basis data for determining a known execution file.

Information 501 transferred from the monitoring apparatus 111 to the diagnosis apparatus 110 is information regarding a known malicious file and an unknown malicious/normal file. For a known malicious file, <IP, port, file index, time> information is transferred to provide information regarding a malicious file distribution, and for an unknown malicious/normal file, an assembled execution file is additionally transferred along with the foregoing information. The diagnosis apparatus 110 determines whether the transferred execution file is malicious through diagnosis by various anti-virus engines.

FIG. 3 illustrates a detailed block diagram of the monitoring apparatus 111 shown in FIG. 1.

First, an packet collection unit 310, while monitoring the network 120 in a tapping mode, recognizes a pattern (e.g., a PE file format pattern in case of a window execution file: MZ) of a start packet of the execution file among entire packet passing through a link, and collects candidate packets for execution file every packet belonging to a TCP/UDP session corresponding to the pattern.

In this case, the packets needs be separately collected by TCP/UDP session, so a TCP/UDP session table corresponding to 5-tuple (Src/Dst IP, Port, Protocol) is preferred to be maintained. The packets collected by the packet collection unit 310 are finally assembled into a single complete file by an information transferring unit 311. The assembling process is similar to a procedure of a TCP reassembly protocol, and the assembled file is subject to a TCP sequence number checking process during assembling to create the assembled file as complete as possible.

The packet collecting in the network 120 may entails several problems as follow. First, packets may not be collected in order or necessary packets may not be collected. In this case, a perfect execution file may not be collected although TCP reassembling is performed. Second, the sizes of headers of application programs (information for controlling the application programs) used for transmitting files are all different depending on the application programs, and thus the full size of the headers may not be accurately executed in some cases. Therefore, a perfect execution file may not be collected. Third, when the session is forcibly terminated (RST), an execution file may not be collected.

As described above, an IP packet may be lost in the network, so a file generation of 100% may not be made. However, it is noted that there is a low possibility causing problems in creating a file index. A best-effort (BE) concept is preferably used to enhance the generation of an execution file. The generated execution file is stored in an execution file storage unit 309.

A comparison unit 312 infers a hash value and a length of the execution file for a file index. As the file hash value, an MD5 hash value is taken for data corresponding to a front fixed length (e.g., 300 bytes) of the execution file, and a file size extracted from the execution file header information is calculated. The extracted index <hash value, file size> can be utilized as an index for uniquely identifying the execution file although the execution file is not completely assembled.

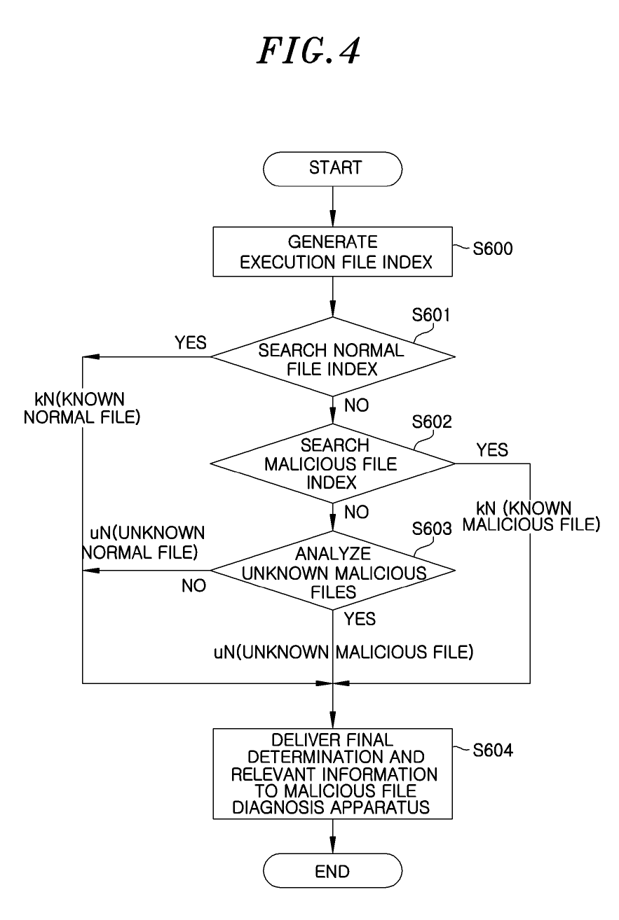

The index storage unit 314 stores therein indices of malicious execution files and the index storage unit 315 stores therein indices of normal execution files. The monitoring apparatus 111 checks whether the execution file is a known execution file by searching the index storage unit 315 and the index storage unit 314 using the newly extracted index. The results finally determined by the monitoring apparatus 111 through the comparison unit 312 and the analysis unit 313 include four cases as shown in FIG. 4 below.

FIG. 4 illustrates a flowchart for explaining a process of testing an execution file by the monitoring apparatus 111 shown in FIG. 1.

First, in step S600, a file index is extracted from for an execution file. In step S601, the index storage unit 315 is searched to determine whether or not the extracted index is found in the index storage unit 315. If the extracted file index is found in the index storage unit 315, the execution file is determined as the known normal file (kN).

If, however, the extracted file index is not found in the index storage unit 315, the process advances to step S602. In step S602, the index storage unit 314 is searched to determine whether or not the extracted index is found in the index storage unit 314. If the extracted file index is found in the index storage unit 314, the execution file is determined as the known malicious file (kA).

Meanwhile, in step S602, if the extracted file index is not also found in the index storage unit 314, the process goes to step S603. In step S603, it is finally determined whether it is an unknown malicious file or unknown normal file through the analysis unit 313. For example, such a determination by the analysis unit 313 may be made based on whether or not a file header has an error, randomness of file content, or the like.

A final determination with respect to the execution file assembled in the network 120 in this manner and relevant information 501 (see FIG. 2) are delivered to the diagnosis apparatus 110 through the information transferring unit 316.

FIG. 5 illustrates a detailed block diagram of the diagnosis apparatus 110 shown in FIG. 1.

Referring to FIG. 5, the diagnosis apparatus 110 serves to collect information regarding every malicious file or code distributed in a management network such as an enterprise network, campus network, subscriber network, AS, etc. and unknown execution files through an information transferring unit 204, store the collected execution files in an execution file storage unit 203, and finally determine whether the respective collected execution files are malicious by using various anti-virus engines 209.

For example, a commercially available anti-virus engine may be implemented as the anti-virus engine 209, and about commercial 10 anti-virus engines may suffice to catch most of the latest malicious information. This provides a great advantage in that no anti-virus engine is installed in terminals attempting to access the management network.

Further, when an execution file provided from the monitoring apparatus 111 is finally determined to be a malicious file, it means that the malicious file has been introduced via the management network and there is any infected terminal. Information thereon is maintained by the management unit 205.

In order to cope with the situation, the distribution management unit 205 provides information for removing the infected malicious file to the malicious file removing agents 113 and 114 through the information transferring unit 204. In addition, when a malicious file and a normal execution file newly are obtained by an operator through a different route such as off-line and introduced through a user interface unit 207, a hash generation unit 208 stores indices of the new malicious and normal execution file in the hash storage unit 201 and the hash storage unit 202, respectively. The information transferring unit 204 then transfers the information 502 regarding the new malicious and normal file to the monitoring apparatus 111, so that the index storage units 314 and 315 is newly updated with the information 502.

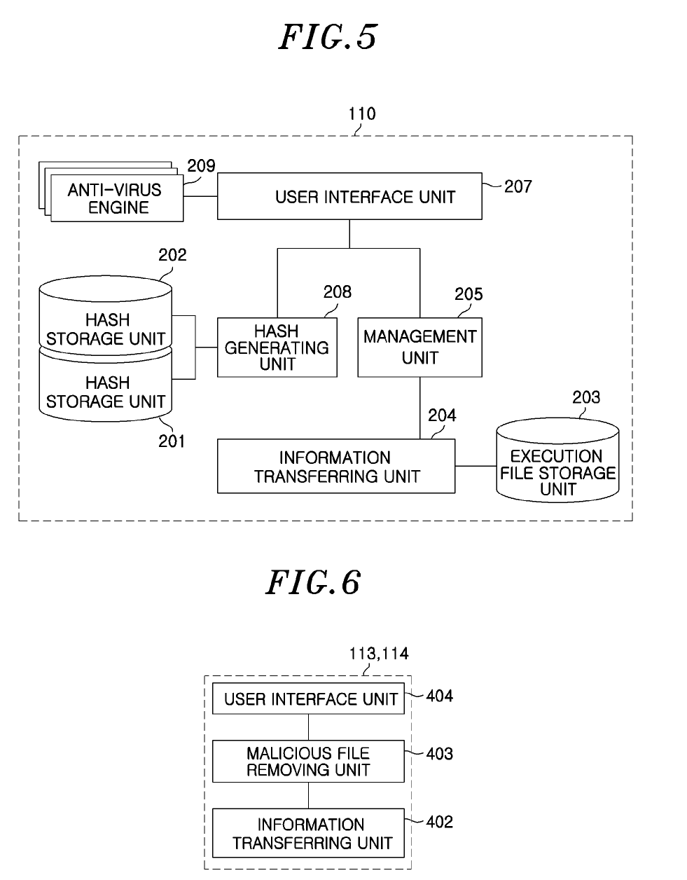

FIG. 6 illustrates a detailed block diagram of the malicious file removing agents 113 and 114 shown in FIG. 1.

The malicious file removing agents 113 and 114 are installed in a personal computer (PC) or a mobile terminal such as a personal data assistant (PDA) and a cellular phone, as set forth above, to remove a malicious file based on the information provided from the monitoring apparatus 111. None anti-virus engine needs to be loaded in the malicious file removing agents 113 and 114 and the function for malicious file removing is very simple, so there is little load for installation and operation.

The malicious file removing agents 113 and 114 includes an information transferring unit 402, a malicious file removing unit 403, and a user interface 404. The malicious file removing agents 113 and 114 receives information on any malicious file from the monitoring apparatus 111 through the information transferring unit 402, and provide that information to a user through the user interface unit 404. In accordance with that information, the malicious file removing unit 403 removes a malicious file depending on a user selection or automatically without a user selection. Since there is no need to load an anti-virus engine, the malicious file removing agents 113 and 114 are advantageously lightweight, and can remove a malicious file using the anti-virus engine service provided from the cloud computing based communication system.

The malicious diagnosis method and the malicious file monitoring method in accordance with the embodiments of the present invention as described above may be implemented with a computer program. Codes and code segments constituting the computer program may be easily inferred by those skilled in the art. Further, the computer program may be stored in a computer-readable storage medium that can be read by a computer, and read and executed by a computer, the diagnosis apparatus or the monitoring apparatus in accordance with the present invention, or the like, thereby implementing the malicious diagnosis method or the malicious file monitoring method. The computer-readable storage medium includes a magnetic recording medium, an optical recording medium, and a carrier wave medium.

In accordance with the embodiments of the present invention, a malicious file causing a harmful behavior such as a DDoS attack or a leakage of internal information can be managed and monitored in the cloud computing-based network, and therefore a personal computer or a mobile terminal device in the management network can adopt a malicious file management policy provided in the management network without having to install an anti-virus engine therein. Thus, each individual can be free from updating of various anti-virus engines, and in particular, a mobile light-weight terminal can advantageously avoid a waste of additional computing resource for detecting a malicious file. It is impossible to apply various anti-virus engines to numerous terminals in the management network, but since the cloud computing-based anti-virus engine service is provided, various anti-virus engine services can be simultaneously received, and a security service in the form of security as a service (SaaS) in which cost is paid for a service in use can be provided. Also, since a distributor of a malicious file can be precisely recognized, an appropriate action can be taken for the distributor later.

While the invention has been shown and described with respect to the particular embodiments, it will be understood by those skilled in the art that various changes and modification may be made without departing from the scope of the invention as defined in the following claims.

What is claimed is:

1. An apparatus for diagnosing malicious files, the apparatus comprising:
an information transferring unit configured to receive information regarding a malicious file distributed in a management network and an execution file generated by assembling packets collected from the management network;
an anti-virus engine configured to determine whether or not the execution file is malicious to generate information regarding a new malicious file; and
a management unit configured to transfer the information regarding the malicious file and the information regarding the new malicious file to a terminal device on the management network through the information transferring unit.

2. The apparatus of claim 1, further comprising:
a hash generating unit for generating an index including a hash value of the execution file,
wherein the management unit transfers the index generated by the hash generating unit to the management network so that the index is used to monitor a malicious file.

3. A method for diagnosing malicious files, the method comprising:
receiving information regarding a malicious file distributed in a management network and an execution file generated by assembling packets collected from the management network;
determining whether or not the execution file is malicious by using an anti-virus engine;
generating information regarding a new malicious file based on the determination result; and
transferring the information regarding the malicious file and the information regarding the new malicious file to a terminal device on the management network.

4. The method of claim 3, further comprising:
generating an index including a hash value of the execution file,
transferring the generated index to the management network so that the index is used to monitor a malicious file.

5. An apparatus for monitoring malicious files, the apparatus comprising:
an packet collection unit configured to collect packets from a network when the packets are recognized as candidate packets of execution files;
an information transferring unit configured to assemble the collected candidate packets to generate an execution file;
an index storage unit configured to store an index of malicious files;
a comparison unit configured to compare an index of the execution file with the indices of the malicious files stored in the index storage unit to determine whether or not the execution file is a malicious file based on the comparison result;
a malicious file analyzing unit configured to determine whether or not the execution file, which has not been determined by the comparison unit, is a malicious file; and
a information transferring unit configured to transfer the determination result for the execution files obtained by the comparison unit and the malicious file analyzing unit to the network so that the result is used to diagnose the malicious files.

6. The apparatus of claim 5, wherein the malicious file analyzing unit determines a malicious file based on whether a file header has an error or randomness of file content.

7. The apparatus of claim 5, further comprising:
a second index storage unit configured to store indices of normal files,
wherein the comparison unit compares an index of the execution file with the indices of the normal files stored in the second index storage unit to determine whether or not the execution file is a normal file, and
wherein the information transferring unit transfers information regarding a distribution path of the execution file determined as a malicious file by the comparison unit to the network,
wherein the information transferring unit transfers the execution file which has not been determined by the comparison unit, along with the information regarding a distribution path, to the network.

8. A method for monitoring malicious files, the method comprising:
collecting packets from a network when the packets are recognized as candidate packets of execution files;
assembling the candidate packets to generate an execution file;
extracting an index including a hash value from the execution file;
comparing the index of the execution file with the indices of malicious files to determine whether or not the execution file is a malicious file; and
transferring a determination result to the network so that the determination result is used to diagnose or remove malicious files.

9. The method of claim 8, further comprising:
comparing an index of the execution file with indices of normal files to determine whether the execution file is a normal file,
wherein said transferring a determination result includes:
transferring information regarding a distribution path of the execution file determined as a malicious file to the network; and
transferring the execution file which has not been determined by the comparison unit, along with the information regarding a distribution path, to the network.

10. The method of claim 8, wherein the index of the execution includes a hash value and a file size.
